(19) United States
(12) Patent Application Publication
(10) Pub. No.: US 2025/0225673 A1
(43) Pub. Date: Jul. 10, 2025

(54) Method For Measuring Volume Of Object By Estimating Base Through Aligning

(71) Applicant: NUVILABS Co., Ltd., Seo-gu (KR)

(72) Inventors: Jinyong KIM, Seoul (KR); Seungmin HAN, Gyeongsangbuk-do (KR)

(73) Assignee: NUVILABS Co., Ltd., Seo-gu (KR)

(21) Appl. No.: 19/010,787

(22) Filed: Jan. 6, 2025

(30) Foreign Application Priority Data
Jan. 8, 2024 (KR) 10-2024-0002692

(51) Int. Cl. G06T 7/62; G06T 7/30

(52) U.S. Cl. CPC G06T 7/62; G06T 7/30; G06T 2207/10028

(57) ABSTRACT

Disclosed is a method of predicting a volume of an object, the method being performed by one or more processors of a computing device, the method including: obtaining first multi-dimensional data of a container without containing an object and second multi-dimensional data of the container containing the object; aligning the first multi-dimensional data with the second multi-dimensional data; predicting a base plane of the object based on the aligned first and second multi-dimensional data; and calculating a volume of the object based on the predicted base plane of the object.

### CROSS-REFERENCE TO RELATED APPLICATIONS

This application claims priority to and the benefit of Korean Patent Application No. 10-2024-0002692 filed in the Korean Intellectual Property Office on Jan. 8, 2024, the entire contents of which are incorporated herein by reference.

### TECHNICAL FIELD

The present disclosure relates to a method of measuring a volume of an object, and more specifically, to a method of estimating a base plane through matching by using multi-dimensional data of a container containing an object and a container containing the object and measuring a volume of the object based on the estimated base plane.

### BACKGROUND ART

In the past, various methods, such as video analysis and photographic measurement, measurement using a measuring device, and measurement using geometric modeling, have been used to calculate the loaded quantity of food waste. However, in the case of video analysis and photographic measurement, an appropriate angle and lighting are required for accurate volume measurement, and there is a problem that the accuracy may be reduced due to fluctuations in texture or color. In addition, in the case of the method using a measuring device, there is a problem that it is difficult to estimate the volume of food with a variable density only by weight. Therefore, recently, a method of measuring the volume by taking a picture of food on a food tray with a depth camera was used. In this regard, in order to measure the volume of an object contained in a container well through a depth camera, the base plane needs to be well estimated and the error in the area of the base plane needs not to be large. However, when measuring the volume of an object contained in a container through a depth camera, there is a problem that the base plane of the food is difficult to see because the picture taken from above of the food tray containing food is generally used. Therefore, there is a need for a method capable of accurately predicting the volume of an object by using a depth camera and at the same time estimating an invisible base plane of an object well.

On the other hand, the present disclosure has been derived based on at least the technical background discussed above, but the technical problem or purpose of the present disclosure is not limited to solving the problems or disadvantages discussed above. That is, the present disclosure may cover various technical issues related to the content to be described below in addition to the technical issues discussed above.

### SUMMARY OF THE INVENTION

The present disclosure is conceived in response to the background art, and has been made in an effort to provide a method of measuring a volume of an object, which, more particularly, estimates a base plane through matching by using multi-dimensional data of a container without containing an object and a container containing the object and more accurately measures a volume of the object based on the estimated base plane.

On the other hand, the technical problem to be achieved by the present disclosure is not limited to the technical problem mentioned above, and various technical problems may be included within the range obvious to those skilled in the art from the content to be described below.

An exemplary embodiment of the present disclosure provides a method of predicting a volume of an object, the method being performed by one or more processors of a computing device, the method including: obtaining first multi-dimensional data of a container without containing an object and second multi-dimensional data of the container containing the object; aligning the first multi-dimensional data with the second multi-dimensional data; predicting a base plane of the object based on the aligned first and second multi-dimensional data; and calculating a volume of the object based on the predicted base plane of the object.

Alternatively, the obtaining of the first multi-dimensional data of the container without containing the object and the second multi-dimensional data of the container containing the object may include: acquiring the first multi-dimensional data through a multi-dimensional precise scan of the container without containing the object; and obtaining the second multi-dimensional data for the container containing the object by using a depth camera.

Alternatively, the aligning of the first multi-dimensional data with the second multi-dimensional data may include: setting a first axis among a plurality of orthogonal axes included in the first multi-dimensional data; setting a second axis among a plurality of orthogonal axes included in the second multi-dimensional data; and aligning the first multi-dimensional data with the second multi-dimensional data based on the first axis and the second axis.

Alternatively, the aligning of the first multi-dimensional data with the second multi-dimensional data based on the first axis and the second axis may include: aligning the first axis and the second axis, and calculating a degree of agreement between the first multi-dimensional data and the second multi-dimensional data; and aligning the first multi-dimensional data and the second multi-dimensional data based on the degree of agreement.

Alternatively, the aligning of the first axis and the second axis, and the calculating of the degree of agreement between the first multi-dimensional data and the second multi-dimensional data may include: aligning the first axis and the second axis, and calculating a first degree of agreement between the first multi-dimensional data and the second multi-dimensional data; aligning the first axis and the second axis, and calculating a second degree of agreement between a first-1 multi-dimensional data obtained by rotating the first multi-dimensional data, and the second multi-dimensional data; and aligning the first multi-dimensional data with the second multi-dimensional data based on the first degree of agreement and the second degree of agreement.

Alternatively, the aligning of the first axis and the second axis, and the calculating of the degree of agreement between the first multi-dimensional data and the second multi-dimensional data may include: aligning the first axis and the second axis and moving a position of a center point of the first multi-dimensional data in parallel within a preset range; and calculating the degree of agreement between the first multi-dimensional data of which the center point has moved in parallel and the second multi-dimensional data.

Alternatively, the aligning of the first axis and the second axis, and the calculating of the degree of agreement between the first multi-dimensional data and the second multi-dimensional data may include: performing sampling on the first multi-dimensional data and obtaining sampled first multi-dimensional data; and aligning the first axis and the second axis, and calculating the degree of agreement between the sampled first multi-dimensional data and the second multi-dimensional data.

Alternatively, the performing of the sampling on the first multi-dimensional data and the obtaining of the sampled first multi-dimensional data may include: calculating a histogram of the second multi-dimensional data; removing a portion of the histogram of the second multi-dimensional data whose distribution is equal to or less than a preset threshold; and performing sampling on the first multi-dimensional data based on the second multi-dimensional data from which the portion equal to or less than the preset threshold is removed, and obtaining the sampled first multi-dimensional data.

Alternatively, the performing of the sampling on the first multi-dimensional data and the obtaining of the sampled first multi-dimensional data may include: obtaining a normal vector of each of point data included in the first multi-dimensional data; and performing sampling on the first multi-dimensional data based on the obtained normal vector of each of the point data and obtaining the sampled first multi-dimensional data.

Alternatively, the sampling of the first multi-dimensional data based on the obtained normal vector of each of the point data and the obtaining of the sampled first multi-dimensional data may include: calculating a degree of redundancy for the obtained normal vector of each of the point data; and sampling the obtained point data based on the calculated degree of redundancy.

Alternatively, the sampling of the obtained point data based on the calculated degree of redundancy may include at least one of: sampling less point data of a first group including a normal vector with the high degree of redundancy; and sampling a lot of point data of a second group including the normal vector with the low degree of redundancy.

Alternatively, the predicting of the base plane of the object based on the aligned first and second multi-dimensional data may include predicting a space between the object and the second multi-dimensional data based on the aligned first multi-dimensional data and second multi-dimensional data.

Alternatively, the calculating of the volume of the object based on the predicted base plane of the object may include calculating the volume of the object based on the space between the predicted object and the first multi-dimensional data.

Another exemplary embodiment of the present disclosure provides a computer program stored in a computer-readable storage medium, the computer program causing one or more processors to perform operations to predict a volume of an object when being executed by the one or more processors, the operations including: an operation of obtaining first multi-dimensional data of a container without containing an object and second multi-dimensional data of the container containing the object; an operation of aligning the first multi-dimensional data with the second multi-dimensional data; an operation of predicting a base plane of the object based on the aligned first and second multi-dimensional data; and an operation of calculating a volume of the object based on the predicted base plane of the object.

Alternatively, the operation of obtaining the first multi-dimensional data of the container without containing the object and the second multi-dimensional data of the container containing the object may include: an operation of obtaining the first multi-dimensional data through a multi-dimensional precise scan of the container without containing the object; and an operation of obtaining the second multi-dimensional data for the container containing the object by using a depth camera.

Alternatively, the operation of aligning the first multi-dimensional data with the second multi-dimensional data may include: an operation of setting a first axis among a plurality of orthogonal axes included in the first multi-dimensional data; an operation of setting a second axis among a plurality of orthogonal axes included in the second multi-dimensional data; and an operation of aligning the first multi-dimensional data with the second multi-dimensional data based on the first axis and the second axis.

Alternatively, the operation of aligning the first multi-dimensional data with the second multi-dimensional data based on the first axis and the second axis may include: an operation of aligning the first axis and the second axis, and calculating a degree of agreement between the first multi-dimensional data and the second multi-dimensional data; and an operation of aligning the first multi-dimensional data and the second multi-dimensional data based on the degree of agreement.

Alternatively, the operation of aligning of the first axis and the second axis, and calculating the degree of agreement between the first multi-dimensional data and the second multi-dimensional data may include: an operation of aligning the first axis and the second axis, and calculating a first degree of agreement between the first multi-dimensional data and the second multi-dimensional data; an operation of aligning the first axis and the second axis, and calculating a second degree of agreement between a first-1 multi-dimensional data obtained by rotating the first multi-dimensional data, and the second multi-dimensional data; and an operation of aligning the first multi-dimensional data with the second multi-dimensional data based on the first degree of agreement and the second degree of agreement.

Alternatively, the operation of aligning of the first axis and the second axis, and calculating the degree of agreement between the first multi-dimensional data and the second multi-dimensional data may include: an operation of aligning the first axis and the second axis and moving a position of a center point of the first multi-dimensional data in parallel within a preset range; and an operation of calculating the degree of agreement between the first multi-dimensional data of which the center point has moved in parallel and the second multi-dimensional data.

Alternatively, the operation of aligning of the first axis and the second axis, and calculating the degree of agreement between the first multi-dimensional data and the second multi-dimensional data may include: an operation of performing sampling on the first multi-dimensional data and obtaining sampled first multi-dimensional data; and an operation of aligning the first axis and the second axis, and calculating the degree of agreement between the sampled first multi-dimensional data and the second multi-dimensional data.

Alternatively, the operation of performing of the sampling on the first multi-dimensional data and obtaining the sampled first multi-dimensional data may include: an operation of calculating a histogram of the second multi-dimensional data; an operation of removing a portion of the histogram of the second multi-dimensional data whose distribution is equal to or less than a preset threshold; and an operation of performing sampling on the first multi-dimensional data based on the second multi-dimensional data from which the portion equal to or less than the preset threshold is removed, and obtaining the sampled first multi-dimensional data.

Alternatively, the operation of performing of the sampling on the first multi-dimensional data and obtaining the sampled first multi-dimensional data may include: an operation of obtaining a normal vector of each of point data included in the first multi-dimensional data; and an operation of performing sampling on the first multi-dimensional data based on the obtained normal vector of each of the point data and obtaining the sampled first multi-dimensional data.

Alternatively, the operation of predicting the base plane of the object based on the aligned first and second multi-dimensional data may include an operation of predicting a space between the object and the first multi-dimensional data based on the aligned first multi-dimensional data and second multi-dimensional data.

Alternatively, the operation of calculating the volume of the object based on the predicted base plane of the object may include an operation of calculating the volume of the object based on the space between the predicted object and the first multi-dimensional data.

Still another exemplary embodiment of the present disclosure provides a computing device including: at least one processor; and a memory, in which the at least one processor is configured to: obtain first multi-dimensional data of a container without containing an object and second multi-dimensional data of the container containing the object; align the first multi-dimensional data with the second multi-dimensional data; predict a base plane of the object based on the aligned first and second multi-dimensional data; and calculate a volume of the object based on the predicted base plane of the object.

Still yet another exemplary embodiment of the present disclosure provides a data structure included in a computer-readable storage medium, the data structure corresponding to a parameter of a neural network, the neural network performing following operations based on at least a portion of the parameters, the operations including: obtaining first multi-dimensional data of a container without containing an object and second multi-dimensional data of the container containing the object; aligning the first multi-dimensional data with the second multi-dimensional data; predicting a base plane of the object based on the aligned first and second multi-dimensional data; and calculating a volume of the object based on the predicted base plane of the object.

The method of measuring a volume of an object according to the present disclosure may estimate a base plane through matching by using multi-dimensional data of a container without containing an object and a container containing the object and more accurately measure a volume of the object based on the estimated base plane.

On the other hand, the effect of the present disclosure is not limited to the above-mentioned effects, and various effects may be included within the range apparent to those skilled in the art from the content to be described below.

### BRIEF DESCRIPTION OF THE DRAWINGS

FIG. 1 is a block diagram of a computing device for measuring a volume of an object according to an exemplary embodiment of the present disclosure.

FIG. 2 is a schematic diagram illustrating a network function according to an exemplary embodiment of the present disclosure.

FIG. 3 is a flowchart illustrating a method of measuring a volume of an object according to an exemplary embodiment of the present disclosure.

FIG. 4 is a schematic diagram for illustrating a process of aligning first multi-dimensional data and second multi-dimensional data according to the exemplary embodiment of the present disclosure.

FIG. 5 is a schematic diagram for illustrating a process of moving a position of a center point of the first multi-dimensional data in parallel within a preset range and calculating the degree of agreement between the first multi-dimensional data of which the center point has moved in parallel and the second multi-dimensional data according to the exemplary embodiment of the present disclosure.

FIG. 6 is a schematic diagram for illustrating a process of performing sampling on first multi-dimensional data and obtaining sampled first multi-dimensional data according to the exemplary embodiment of the present disclosure.

FIG. 7 is a schematic diagram for illustrating a process of performing sampling on the first multi-dimensional data using a normal vector of each point data included in the first multi-dimensional data and obtaining the sampled first multi-dimensional data according to an exemplary embodiment of the present disclosure.

FIG. 8 is a simple and general schematic diagram for an example of a computing environment in which exemplary embodiments of the present disclosure are implementable.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

FIG. 1 is a block diagram of a computing device for measuring a volume of an object according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

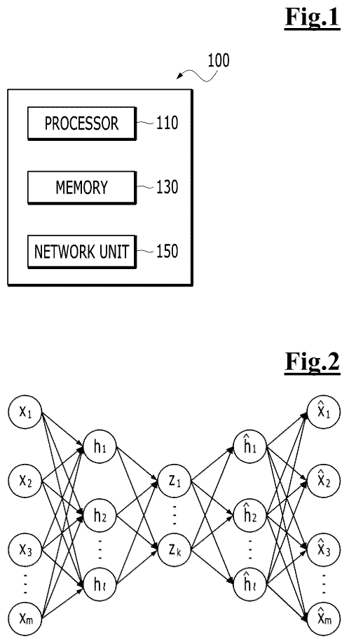

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

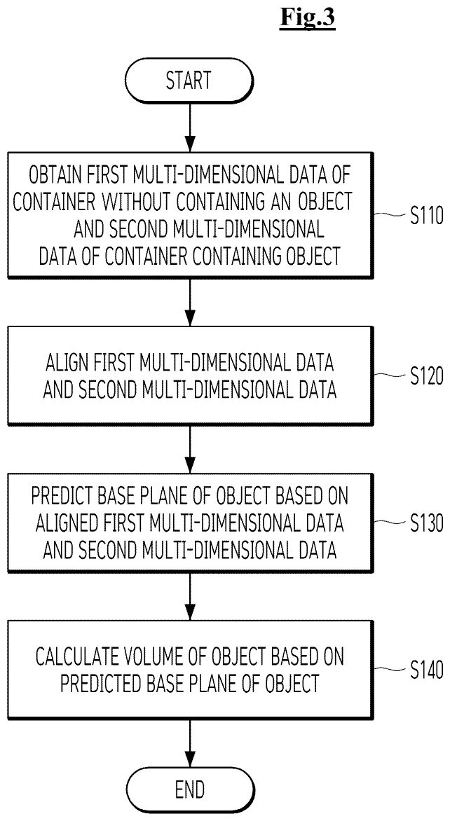

FIG. 3 is a flowchart illustrating a method of measuring a volume of an object according to an exemplary embodiment of the present disclosure.

The computing device 100 according to the exemplary embodiment of the present disclosure may directly obtain “information for measuring a volume of an object” or receive “information for measuring a volume of an object” from an external system. The external system may be a server, a database, or the like that stores and manages information for measuring a volume of an object. The computing device 100 may use information directly obtained or received from an external system as “input data for measuring the volume of the object”.

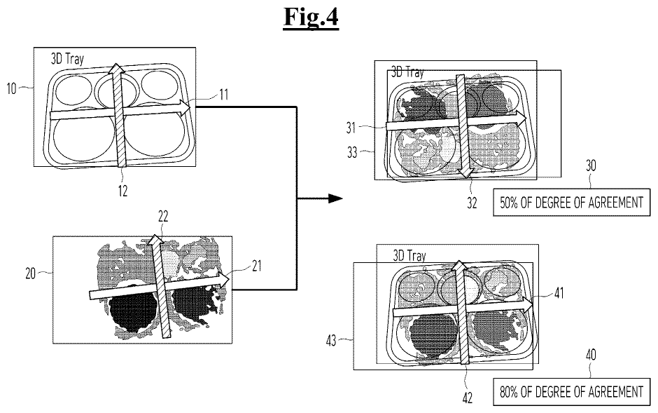

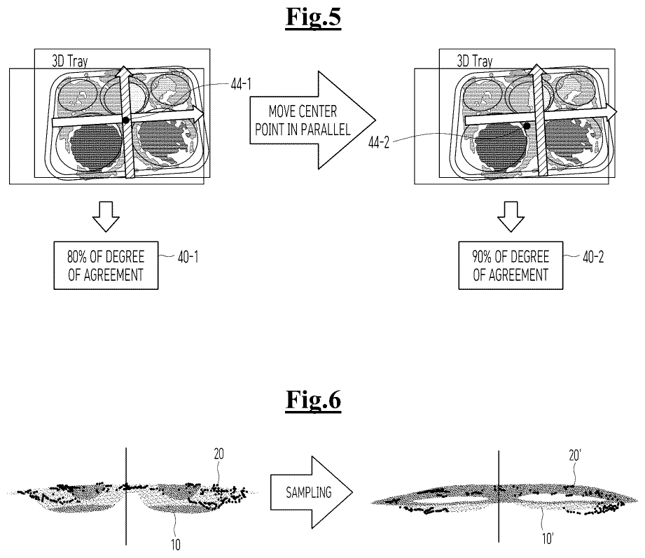

According to the exemplary embodiment of the present disclosure, the computing device 100 may obtain first multi-dimensional data of a container without containing an object and second multi-dimensional data of the container containing the object (S110). In this case, the computing device 100 may obtain the first multi-dimensional data through a multi-dimensional precise scan of the container without containing the object, and obtain the second multi-dimensional data for the container containing the object by using a depth camera. For example, in the process of obtaining the first multi-dimensional data through the multi-dimensional precise scan, technologies, such as laser scanning, structured light scanning, time-of-flight camera, stereo vision system, and photogrammetry, may be used, and the multi-dimensional data may include 3D data, but the present disclosure is not limited thereto. On the other hand, in the process of obtaining the second multi-dimensional data, technologies, such as laser scanning, structured light scanning, time-of-flight cameras, stereo vision systems, and photogrammetry, may be also used in addition to the method of utilizing a depth camera, and the present disclosure is not limited to examples such as the depth camera. In addition, the depth camera may refer to a camera that measures distance information to a specific point of an environment or object, and the depth camera may include, for example, a camera that secures 3D information of space by measuring a depth value of each pixel in a 2D image. Meanwhile, the computing device 100 may align the obtained first and second multi-dimensional data and use the aligned first and second multi-dimensional data to calculate the volume of an object to be described later, and the description thereof will be given below with reference to FIGS. 4 to 5.

According to the exemplary embodiment of the present disclosure, the computing device 100 may align the first multi-dimensional data and the second multi-dimensional data obtained through operation S110 (S120). Specifically, the computing device 100 may set a first axis among a plurality of orthogonal axes included in the first multi-dimensional data, set a second axis among a plurality of orthogonal axes included in the second multi-dimensional data, and align the first multi-dimensional data and the second multi-dimensional data based on the first axis and the second axis. For example, the computing device 100 may identify the longest axis, the second longest axis, the third longest axis among a plurality of axes orthogonal to each of the first multi-dimensional data or the second multi-dimensional data, set a first axis of the first multi-dimensional data based on the longest direction among the three axes, set a second axis based on the direction of the longest vector included in the second multi-dimensional data, and may align the first multi-dimensional data and the second multi-dimensional data based on the first axis and the second axis. As a specific example, the first and second multi-dimensional data on the container without containing the object may be multi-dimensional data for a container with a set standard, and for example, a food tray for distribution may be included. In this case, when the first and second multi-dimensional data of the container without containing the object are a food tray for distribution, the horizontal length is relatively longer than the vertical length, so it may be easy to align the first and second axes when the axes of the multi-dimensional data are set based on the long horizontal direction. In this regard, the computing device 100 may align the first axis and the second axis, calculate the degree of agreement between the first multi-dimensional data and the second multi-dimensional data, and align the first multi-dimensional data and the second multi-dimensional data based on the degree of agreement. Specifically, the computing device 100 may align the first axis and the second axis, calculate a first degree of agreement between the first multi-dimensional data and the second multi-dimensional data, align the first axis and the second axis, calculate a second degree of agreement between a first-1 multi-dimensional data obtained by rotating the first multi-dimensional data and the second multi-dimensional data, and align the first multi-dimensional data and the second multi-dimensional data based on the first degree of agreement and the second degree of agreement. In this regard, even when the first axis and the second axis are aligned so that the horizontal and vertical ratios of the multi-dimensional data are appropriate, the computing device 100 may have the degree of agreement depending on the direction of the multi-dimensional data. For example, when the multi-dimensional data is a food tray, the size of the space in which side dishes are stored is smaller than the size in which soup and rice are stored, and thus, a process of checking whether the multi-dimensional data are aligned in the correct direction after aligning the first axis and the second axis is required to calculate an accurate volume of the object contained in the container. Accordingly, the computing device 100 may align the first and second axes, and may align the first multi-dimensional data and the second multi-dimensional data in a direction exhibiting the higher degree of agreement between “the first degree of agreement calculated between the first multi-dimensional data and the second multi-dimensional data” and “a second degree of agreement calculated between the first multi-dimensional data rotated by 180 degrees and the second multi-dimensional data”. Accordingly, the computing device 100 may compare the first multi-dimensional data of the container without containing the object and the second multi-dimensional data of the container containing the object to use the result of the comparison to the process of calculating the volume of the object.

Additionally, the computing device 100 may align the first axis and the second axis, move the position of the center point of the first multi-dimensional data in parallel within a preset range, and calculate the degree of agreement between the first multi-dimensional data of which the center point has moved in parallel and the second multi-dimensional data. In this regard, when the second multi-dimensional data of the container containing the object is obtained through the depth camera, a part of the container containing the object may be covered, in which case the z-value of the center point may not be accurate. In addition, due to the nature of the depth camera, the measured depth may be measured lower than it actually is when the container containing the object is a material with severe light reflection, such as a food tray. Thus, the computing device 100 may correct errors related to the depth camera and more accurately align the first and second multi-dimensional data by aligning the first axis and the second axis, moving the position of the center point of the first multi-dimensional data in parallel within a preset range, and calculating the degree of agreement between the first multi-dimensional data of which the center point has moved in parallel and the second multi-dimensional data. Meanwhile, the specific process in which the computing device 100 moves the position of the center point of the first multi-dimensional data in parallel within a preset range, and calculates the degree of agreement between the first multi-dimensional data of which the center point has moved in parallel and the second multi-dimensional data will be described later with reference to FIG. 5.

According to the exemplary embodiment of the present disclosure, the computing device 100 may perform sampling on the first multi-dimensional data, obtain the sampled first multi-dimensional data, align the first axis and the second axis, and calculate the degree of agreement between the sampled first multi-dimensional data and the second multi-dimensional data. In this regard, according to the exemplary embodiment of the present disclosure, the process of predicting the volume of the object for the container containing the object by the computing device 100 may be performed in real time. In this case, when the first multi-dimensional data is obtained through a multi-dimensional precise scan, the size of the data is large, so it may take some time to calculate the degree of agreement with the second multi-dimensional data or the volume of the object included in the second multi-dimensional data. Accordingly, the computing device 100 may sample the first multi-dimensional data in the process of predicting the volume of the object, and use the sampled first multi-dimensional data to reduce the operation time and obtain accurate prediction results. As a specific example, the computing device 100 may calculate a histogram of the second multi-dimensional data and remove a portion of the histogram of the second multi-dimensional data having a distribution equal to or less than a preset threshold. In addition, the computing device 100 may sample the first multi-dimensional data based on the second multi-dimensional data from which the portion equal to or less than the preset threshold is removed, and obtain the sampled first multi-dimensional data. In this regard, when the second multi-dimensional data for the container containing the object is obtained through the depth camera, information on the base plane contacted by the object may be lost. In contrast, since the first multi-dimensional data of the container without containing the object may be obtained through the multi-dimensional precise scan, the first multi-dimensional data includes information on the base plane unlike the second multi-dimensional data. Accordingly, the error value may increase in the process in which the computing device 100 aligns the second multi-dimensional data with which information on the base plane contacted by the object is lost and the first multi-dimensional data including the information about the base plane and calculating the degree of agreement is calculated. Accordingly, the computing device 100 may increase the degree of accuracy in the process of calculating the degree of agreement by removing a portion of the histogram of the second multi-dimensional data whose distribution is equal to or less than the preset threshold and performing sampling on the first multi-dimensional data based on the second multi-dimensional data from which the portion equal to or less than the preset threshold is removed. Meanwhile, a detailed description of the process in which the computing device 100 calculates a histogram of the second multi-dimensional data and removes a portion of the histogram of the second multi-dimensional data whose distribution is equal to or less than a preset threshold will be described later with reference to FIG. 6.

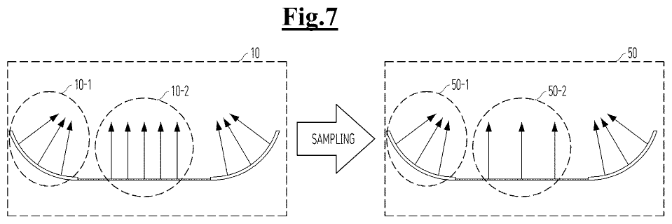

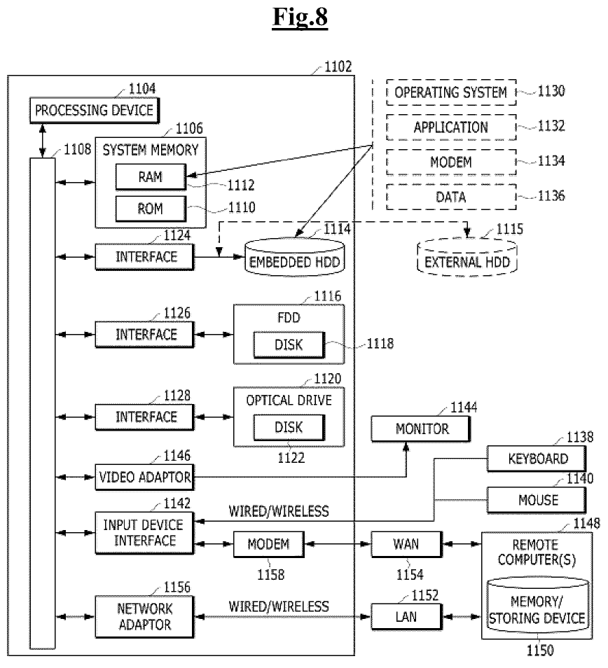

According to another exemplary embodiment of the present disclosure, the computing device 100 may obtain a normal vector of each of point data included in the first multi-dimensional data, perform sampling on the first multi-dimensional data based on the normal vector of each of the obtained point data, and obtain sampled first multi-dimensional data. For example, the computing device 100 may calculate the degree of redundancy for the normal vector of each of the obtained point data and sample the obtained point data based on the calculated degree of redundancy. In this case, the point data included in the first multi-dimensional data may include point cloud data, and the degree of redundancy for the normal vector may mean how many normal vectors with the same direction exist. In addition, the point cloud data may refer to a data format representing a set of points in a three-dimensional (3D) space, each point data represents a specific location in space, and as a set of these point data, the shape of an object or environment in the real world may be expressed. Meanwhile, the computing device 100 may sample the obtained point data by sampling less point data of a first group including the normal vectors having the high degree of redundancy, or sampling a lot the point data of a second group including the normal vectors having the low degree of redundancy. In this regard, since the first multi-dimensional data of the container containing the object may be obtained through a multi-dimensional precise scan, the first multi-dimensional data includes a relatively large amount of information on the base plane compared to the second multi-dimensional data. Accordingly, the error value may increase in the process in which the computing device 100 aligns the second multi-dimensional data with which information on the base plane contacted by the object is lost and the first multi-dimensional data including the information about the base plane and the degree of agreement is calculated. Accordingly, the computing device 100 may increase accuracy in the process of calculating the degree of agreement by sampling less point data on the base plane where there are many normal vectors of the same direction, or by sampling a lot the point data on the rounded part of the container where there are few normal vectors of the same direction to obtain the sampled first multi-dimensional data. Meanwhile, a detailed description of the process in which the computing device 100 samples the first multi-dimensional data using a normal vector of each of the point data included in the first multi-dimensional data and obtains the sampled first multi-dimensional data will be described later with reference to FIG. 7.

According to the exemplary embodiment of the present disclosure, the computing device 100 may predict the base plane of the object based on the first multi-dimensional data and the second multi-dimensional data aligned through operation S120 (S130). For example, the computing device 100 may predict a space between the object and the first multi-dimensional data based on the aligned first multi-dimensional data and the second multi-dimensional data. Specifically, the computing device 100 may predict the space between the object included in the container and the container by comparing the difference between the aligned first multi-dimensional data of the container without containing the object and second multi-dimensional data of the container containing the object. Meanwhile, the predicted base plane of the object may be utilized in the process of calculating the volume of the object to be described later.

According to the exemplary embodiment of the present disclosure, the computing device 100 may calculate the volume of the object based on the base plane of the object predicted through operation S130 (S140). For example, the computing device 100 may calculate the volume of the object based on the predicted space between the object and the first multi-dimensional data. Specifically, the computing device 100 may predict how high the object is configured through the second multi-dimensional data obtained through the depth camera and the aligned first multi-dimensional data, and may calculate the volume of the object based on the predicted base plane of the object (obtained through the space between the object and the first multi-dimensional data) and the predicted height of the object. Through this, the computing device 100 may estimate the base plane through matching by using multi-dimensional data of the container without containing the object and the container containing the object, and calculate the volume of the object based on the estimated base plane to predict the volume of the object more accurately.

FIG. 4 is a schematic diagram for illustrating a process of aligning first multi-dimensional data and second multi-dimensional data according to the exemplary embodiment of the present disclosure.

Referring to FIG. 4, according to the exemplary embodiment of the present disclosure, the computing device 100 may obtain first multi-dimensional data 10 of the container in which an object is to be contained and second multi-dimensional data 20 of a container including the object. In this case, the computing device 100 may obtain the first multi-dimensional data 10 through a multi-dimensional precise scan of the container without containing the object, and obtain the second multi-dimensional data 20 for the container containing the object by using a depth camera. For example, in the process of obtaining the first multi-dimensional data through the multi-dimensional precise scan, technologies, such as laser scanning, structured light scanning, time-of-flight camera, stereo vision system, and photogrammetry, may be used, and the multi-dimensional data (the first or second multi-dimensional data) may include 3D data, but the present disclosure is not limited thereto. On the other hand, in the process of obtaining the second multi-dimensional data, technologies, such as laser scanning, structured light scanning, time-of-flight cameras, stereo vision systems, and photogrammetry, may be also used in addition to the method of utilizing a depth camera, and the present disclosure is not limited to examples such as the depth camera. In addition, the depth camera may refer to a camera that measures distance information to a specific point of an environment or object, and the depth camera may include, for example, a camera that secures 3D information of space by measuring a depth value of each pixel in a 2D image.

In addition, the computing device 100 may set a first axis 11 among a plurality of orthogonal axes included in the first multi-dimensional data 10, set a second axis 21 among a plurality of orthogonal axes included in the second multi-dimensional data 20, and align the first multi-dimensional data 10 and the second multi-dimensional data 20 based on the first (11) axis and the second axis 21. For example, the computing device 100 may identify the longest axis, the second longest axis, the third longest axis among a plurality of axes orthogonal to each of the first multi-dimensional data 10 or the second multi-dimensional data 20, set a first axis 11 of the first multi-dimensional data based on the longest direction among the three axes, set a second axis 21 based on the direction of the longest vector included in the second multi-dimensional data 20, and may align the first multi-dimensional data 10 and the second multi-dimensional data 20 based on the first axis 11 and the second axis 21. As a specific example, the first and second multi-dimensional data 10 and 20 on the container without containing the object may be multi-dimensional data for a container with a set standard, and for example, a food tray for distribution may be included. In this case, when the first and second multi-dimensional data 10 and 20 of the container without containing the object are a food tray for distribution, the horizontal length is relatively longer than the vertical length, so it may be easy to align the first and second axes 11 and 21 when the axes of the multi-dimensional data are set based on the long horizontal direction 11 or 21. However, this is only an example, and various exemplary embodiments of setting the axes of the first and second multi-dimensional data based on the long or short direction of the container in which the standard exists may be used in the process of aligning the first and second axes 11 and 21. Further, the computing device 100 may align the first axis 11 and the second axis 21, calculate the degree of agreement between the first multi-dimensional data 10 and the second multi-dimensional data 20, and align the first multi-dimensional data 10 and the second multi-dimensional data 20 based on the degree of agreement. Specifically, the computing device 100 may align 31 the first axis and the second axis, calculate 30 a first degree of agreement between the first multi-dimensional data and the second multi-dimensional data, align 41 the first axis and the second axis, calculate 40 a second degree of agreement between a first-1 multi-dimensional data obtained by rotating 42 the first multi-dimensional data and the second multi-dimensional data, and align the first multi-dimensional data and the second multi-dimensional data based on the first degree of agreement and the second degree of agreement. In this regard, even when the first axis and the second axis are aligned 31 and 41 so that the horizontal and vertical ratios of the multi-dimensional data are appropriate, the computing device 100 may have the degree of agreement varying depending on the direction of the multi-dimensional data 32 or 42. For example, when the multi-dimensional data is a food tray, the size of the space in which side dishes are stored is smaller than the size in which soup and rice are stored, and thus, a process of checking whether the multi-dimensional data are aligned in the correct direction after aligning the first axis and the second axis is required to calculate an accurate volume of the object contained in the container. In the example of FIG. 4, the result of aligning 31, by the computing device 100, the first axis and the second axis and calculating 30 the first degree of agreement between the first multi-dimensional data and the second multi-dimensional data may be calculated as 50% of the degree of agreement. On the other hand, the result of aligning 41 the first axis and the second axis and calculating 40 a second degree of agreement between a first-1 multi-dimensional data obtained by rotating 42 the first multi-dimensional data and the second multi-dimensional data may be 80% of the degree of agreement. In this case, the computing device 100 may align the first axis and the second axis, and align 43 the first multi-dimensional data 10 and the second multi-dimensional data 20 in a direction exhibiting the higher degree of agreement between “50% of the first degree of agreement calculated 30 between the first multi-dimensional data and the second multi-dimensional data” and “80% of the second degree of agreement calculated 40 between the first multi-dimensional data rotated by 180 degrees and the second multi-dimensional data”. Meanwhile, in addition to the examples, in the process of rotating 42 the first multi-dimensional data, the computing device 100 may calculate 40 the second degree of agreement by using various examples, such as 0 degrees×±30 degrees or 180 degrees ±30 degrees, in addition to 180 degrees. Accordingly, the computing device 100 may compare the first multi-dimensional data of the container without containing the object and the second multi-dimensional data of the container containing the object to use the result of the comparison in the process of calculating the volume of the object. For example, the computing device 100 may predict a space between the object and the first multi-dimensional data based on the aligned first multi-dimensional data and second multi-dimensional data 43. Specifically, the computing device 100 may predict the space between the object included in the container and the first multi-dimensional data by comparing the difference between the aligned first multi-dimensional data of the container without containing the object and second multi-dimensional data of the container containing the object. Further, the computing device 100 may calculate the volume of the object based on the predicted space between the object and the first multi-dimensional data. Specifically, the computing device 100 may predict how high the object is configured through the second multi-dimensional data obtained through the depth camera and the aligned first multi-dimensional data, and may calculate the volume of the object based on the predicted base plane of the object (obtained through the space between the object and the first multi-dimensional data) and the predicted height of the object. Through this, the computing device 100 may estimate the base plane through matching by using multi-dimensional data of the container without containing the object and the container containing the object, and calculate the volume of the object based on the estimated base plane to predict the volume of the object more accurately. On the other hand, various examples for increasing accuracy may be used in the process of aligning the first multi-dimensional data and the second multi-dimensional data to calculate the volume of the object by the computing device 100, and the description will be described later with reference to FIGS. 5 to 7.

FIG. 5 is a schematic diagram for illustrating a process of moving a position of a center point of the first multi-dimensional data in parallel within a preset range and calculating the degree of agreement between the first multi-dimensional data of which the center points has moved in parallel and the second multi-dimensional data according to the exemplary embodiment of the present disclosure.

Referring to FIG. 5, the computing device 100 may align the first axis and the second axis, move a position 44-1 of the center point of the first multi-dimensional data in parallel within a preset range, and calculate 40-2 the degree of agreement between the first multi-dimensional data 44-2 of which the center point has moved in parallel and the second multi-dimensional data. For example, the degree of agreement before the computing device 100 moves the position 44-1 of the center point of the first multi-dimensional data in parallel in the preset range may be calculated as 80%, and the computing device 100 may calculate 40-2 the degree of agreement by moving the position 44-1 of the center point of the first multi-dimensional data in parallel by 1 mm within a range of 0 to 5 mm, which is a preset range based on the z-axis, and the result of the calculation may be 90%. However, the predetermined range of 0 to 5 mm and the parallel movement of 1 mm are merely examples, and various exemplary embodiments may be used. In this regard, when the second multi-dimensional data 20 of the container containing the object is obtained through the depth camera, a part of the container containing the object may be covered, and in this case, the z-value of the center point may not be accurate. In addition, due to the nature of the depth camera, the measured depth may be measured lower than it actually is when the container containing the object is a material with severe light reflection, such as a food tray. Thus, the computing device 100 may correct errors related to the depth camera and more accurately align the first and second multi-dimensional data by aligning 41 the first axis and the second axis, moving the position 44-1 of the center point of the first multi-dimensional data in parallel within a preset range, and calculating 40-2 the degree of agreement between the first multi-dimensional data 44-2 of which the center point has moved in parallel and the second multi-dimensional data. Meanwhile, the computing device 100 may sample the first multi-dimensional data to reduce the amount of computation in the process of predicting the volume of the object, and obtain sampled first multi-dimensional data, and the specific process thereof will be described later with reference to FIGS. 6 and 7.

FIG. 6 is a schematic diagram for illustrating a process of performing sampling on first multi-dimensional data and obtaining sampled first multi-dimensional data according to the exemplary embodiment of the present disclosure.

Referring to FIG. 6, the computing device 100 may perform sampling on the first multi-dimensional data 20 and obtain sampled first multi-dimensional data 10′. In this regard, the process of predicting the volume of the object with respect to the container including the object by the computing device 100 may be performed in real time, but when the first multi-dimensional data 10 is obtained through a multi-dimensional precise scan, the size of the data is large, and thus it may take some time to calculate the degree of agreement with the second multi-dimensional data 20 or the volume of the object included in the second multi-dimensional data. Accordingly, in the process of predicting the volume of the object, the computing device 100 may sample the first multi-dimensional data 10 and obtain an accurate prediction result while reducing the calculation time by using the sampled first multi-dimensional data 10′. As a specific example, the computing device 100 may calculate a histogram of the second multi-dimensional data and remove a portion of the histogram of the second multi-dimensional data having a distribution equal to or less than a preset threshold. In addition, the computing device 100 may sample the first multi-dimensional data based on the second multi-dimensional data 50 from which the portion equal to or less than the preset threshold is removed, and obtain the sampled first multi-dimensional data 10′. In this regard, when the second multi-dimensional data 20 for the container containing the object is obtained through the depth camera, information on the base plane contacted by the object may be lost. In contrast, since the first multi-dimensional data 10 of the container without containing the object may be obtained through the multi-dimensional precise scan, the first multi-dimensional data includes a relatively large amount of information on the base plane unlike the second multi-dimensional data 20. Accordingly, the error value may increase in the process in which the computing device 100 aligns the second multi-dimensional data 20 with which information on the base plane contacted by the object is lost and the first multi-dimensional data 10 including the information about the base plane and calculating the degree of agreement. Accordingly, the computing device 100 may increase the degree of accuracy in the process of calculating the degree of agreement by removing a portion of the histogram of the second multi-dimensional data whose distribution is equal to or less than the preset threshold and performing sampling on the first multi-dimensional data based on the second multi-dimensional data 50 from which the portion equal to or less than the preset threshold is removed. Meanwhile, according to the exemplary embodiment of the present disclosure, the computing device 100 may sample the first multi-dimensional data by using a normal vector of each of the point data included in the first multi-dimensional data in the process of obtaining the sampled first multi-dimensional data, and a detailed description thereof will be described later with reference to FIG. 6.

FIG. 7 is a schematic diagram for illustrating a process of performing sampling on the first multi-dimensional data by using a normal vector of each point data included in the first multi-dimensional data and obtaining the sampled first multi-dimensional data according to the exemplary embodiment of the present disclosure.

Referring to FIG. 7, the computing device 100 may obtain 10-1 and 10-2 a normal vector of each of the point data included in the first multi-dimensional data, perform sampling on the first multi-dimensional data based on the obtained normal vector 10-1 or 10-2 of each of the point data, and obtain the sampled first multi-dimensional data 60. For example, the computing device 100 may calculate the degree of redundancy for the obtained vector 10-1 and 10-2 of each of the point data and sample the obtained point data based on the calculated degree of redundancy. In this case, the point data included in the first multi-dimensional data may include point cloud data, and the degree of redundancy for the normal vector may mean how many normal vectors with the same direction exist. In addition, the point cloud data may refer to a data format representing a set of points in a three-dimensional (3D) space, each point data represents a specific location in space, and as a set of these point data, the shape of an object or environment in the real world may be expressed. Meanwhile, the computing device 100 may sample the obtained point data by sampling 60-1 less point data 10-1 of a first group including the normal vectors having the high degree of redundancy, or sampling 60-2 a lot the point data 10-2 of a second group including the normal vectors having the low degree of redundancy. For example, since the point data of the first group of a flat base plane included in the first multi-dimensional data 10 all contain the normal vectors 10-1 in a similar direction, the computing device 100 may perform less sampling 60-1 on the point data 10-1 of the first group and perform sampling on only three of the five point data. On the other hand, since the point data of the second group of curved surfaces included in the first multi-dimensional data 10 include normal vectors 10-2 in different directions, the computing device 100 may perform a lot sampling on the point data 10-2 of the second group and perform 60-2 all five of the five point data. However, in addition to the examples, various exemplary embodiments may be utilized in the process of sampling the first multi-dimensional data. In this regard, since the first multi-dimensional data 10 of the container without containing the object may be obtained through a multi-dimensional precise scan, information on the base plane may be included unlike the second multi-dimensional data 20. Accordingly, the error value may increase in the process in which the computing device 100 aligns the second multi-dimensional data 20 with which information on the base plane contacted by the object is lost and the first multi-dimensional data 10 including the information about the base plane and calculates the degree of agreement. Accordingly, the computing device 100 may increase accuracy in the process of calculating the degree of agreement by sampling less 60-1 the point data 10-1 of the first group of the base plane where there are many normal vectors of the same direction, or by sampling 60-2 a lot the point data of the second group on the rounded part of the container where there are few normal vectors of the same direction to obtain the sampled first multi-dimensional data 60.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

FIG. 9 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information. It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method of predicting a volume of an object, the method performed by one or more processors of a computing device, the method comprising:
obtaining first multi-dimensional data of a container without containing an object and second multi-dimensional data of the container containing the object;
aligning the first multi-dimensional data with the second multi-dimensional data;
predicting a base plane of the object based on the aligned first and second multi-dimensional data; and
calculating a volume of the object based on the predicted base plane of the object.

2. The method of claim 1, wherein the obtaining of the first multi-dimensional data of the container without containing the object and the second multi-dimensional data of the container containing the object includes:
obtaining the first multi-dimensional data through a multi-dimensional precise scan of the container without containing the object; and
obtaining the second multi-dimensional data for the container containing the object by using a depth camera.

3. The method of claim 1, wherein the aligning of the first multi-dimensional data with the second multi-dimensional data includes:
setting a first axis among a plurality of orthogonal axes included in the first multi-dimensional data;
setting a second axis among a plurality of orthogonal axes included in the second multi-dimensional data; and
aligning the first multi-dimensional data with the second multi-dimensional data based on the first axis and the second axis.

4. The method of claim 3, wherein the aligning of the first multi-dimensional data with the second multi-dimensional data based on the first axis and the second axis includes:
aligning the first axis and the second axis, and calculating a degree of agreement between the first multi-dimensional data and the second multi-dimensional data; and
aligning the first multi-dimensional data and the second multi-dimensional data based on the degree of agreement.

5. The method of claim 4, wherein the aligning of the first axis and the second axis, and the calculating of the degree of agreement between the first multi-dimensional data and the second multi-dimensional data includes:
aligning the first axis and the second axis, and calculating a first degree of agreement between the first multi-dimensional data and the second multi-dimensional data;
aligning the first axis and the second axis, and calculating a second degree of agreement between a first-1 multi-dimensional data obtained by rotating the first multi-dimensional data, and the second multi-dimensional data; and
aligning the first multi-dimensional data with the second multi-dimensional data based on the first degree of agreement and the second degree of agreement.

6. The method of claim 3, wherein the aligning of the first axis and the second axis, and the calculating of the degree of agreement between the first multi-dimensional data and the second multi-dimensional data includes:
aligning the first axis and the second axis and moving a position of a center point of the first multi-dimensional data in parallel within a preset range; and
calculating the degree of agreement between the first multi-dimensional data of which the center point has moved in parallel and the second multi-dimensional data.

7. The method of claim 3, wherein the aligning of the first axis and the second axis, and the calculating of the degree of agreement between the first multi-dimensional data and the second multi-dimensional data includes:
performing sampling on the first multi-dimensional data and obtaining sampled first multi-dimensional data; and
aligning the first axis and the second axis, and calculating the degree of agreement between the sampled first multi-dimensional data and the second multi-dimensional data.

8. The method of claim 7, wherein the performing of the sampling on the first multi-dimensional data and the obtaining of the sampled first multi-dimensional data includes:
calculating a histogram of the second multi-dimensional data;
removing a portion of the histogram of the second multi-dimensional data whose distribution is equal to or less than a preset threshold; and
performing sampling on the first multi-dimensional data based on the second multi-dimensional data from which the portion equal to or less than the preset threshold is removed, and obtaining the sampled first multi-dimensional data.

9. The method of claim 7, wherein the performing of the sampling on the first multi-dimensional data and the obtaining of the sampled first multi-dimensional data includes:
obtaining a normal vector of each of point data included in the first multi-dimensional data; and
performing sampling on the first multi-dimensional data based on the obtained normal vector of each of the point data and obtaining the sampled first multi-dimensional data.

10. The method of claim 9, wherein the performing of the sampling on the first multi-dimensional data based on the obtained normal vector of each of the point data and the obtaining of the sampled first multi-dimensional data includes:
calculating a degree of redundancy for the obtained normal vector of each of the point data; and
sampling the obtained point data based on the calculated degree of redundancy.

11. The method of claim 10, wherein the sampling of the obtained point data based on the calculated degree of redundancy includes at least one of:
sampling fewer points of a first group including a normal vector with the high degree of redundancy; and
sampling more points of a second group including the normal vector with the low degree of redundancy.

12. The method of claim 1, wherein the predicting of the base plane of the object based on the aligned first and second multi-dimensional data includes:
predicting a space between the object and the first multi-dimensional data based on the aligned first multi-dimensional data and second multi-dimensional data.

13. The method of claim 12, wherein the calculating of the volume of the object based on the predicted base plane of the object includes:
calculating the volume of the object based on the space between the predicted object and the first multi-dimensional data.

14. A computer program stored in a non-transitory computer-readable storage medium, the computer program causing one or more processors to perform operations to predict a volume of an object when being executed by the one or more processors, the operations comprising:
an operation of obtaining first multi-dimensional data of a container without containing an object and second multi-dimensional data of the container containing the object;
an operation of aligning the first multi-dimensional data with the second multi-dimensional data;
an operation of predicting a base plane of the object based on the aligned first and second multi-dimensional data; and
an operation of calculating a volume of the object based on the predicted base plane of the object.

15. The computer program of claim 14, wherein the operation of obtaining the first multi-dimensional data of the container without containing the object and the second multi-dimensional data of the container containing the object includes:
an operation of obtaining the first multi-dimensional data through a multi-dimensional precise scan of the container without containing the object; and
an operation of obtaining the second multi-dimensional data for the container containing the object by using a depth camera.

16. The computer program of claim 14, wherein the operation of aligning the first multi-dimensional data with the second multi-dimensional data includes:
an operation of setting a first axis among a plurality of orthogonal axes included in the first multi-dimensional data;
an operation of setting a second axis among a plurality of orthogonal axes included in the second multi-dimensional data; and
an operation of aligning the first multi-dimensional data with the second multi-dimensional data based on the first axis and the second axis.

17. The computer program of claim 16, wherein the operation of aligning of the first axis and the second axis, and calculating the degree of agreement between the first multi-dimensional data and the second multi-dimensional data includes:
an operation of aligning the first axis and the second axis and moving a position of a center point of the first multi-dimensional data in parallel within a preset range; and
an operation of calculating the degree of agreement between the first multi-dimensional data of which the center point has moved in parallel and the second multi-dimensional data.

18. The computer program of claim 16, wherein the operation of aligning of the first axis and the second axis, and calculating the degree of agreement between the first multi-dimensional data and the second multi-dimensional data includes:
an operation of performing sampling on the first multi-dimensional data and obtaining sampled first multi-dimensional data; and
an operation of aligning the first axis and the second axis, and calculating the degree of agreement between the sampled first multi-dimensional data and the second multi-dimensional data.

19. The computer program of claim 14, wherein the operation of predicting the base plane of the object based on the aligned first and second multi-dimensional data includes
an operation of predicting a space between the object and the first multi-dimensional data based on the aligned first multi-dimensional data and second multi-dimensional data.

20. A computing device, comprising:
at least one processor; and
a memory,
wherein the at least one processor is configured to:
obtain first multi-dimensional data of a container without containing an object and second multi-dimensional data of the container containing the object;
align the first multi-dimensional data with the second multi-dimensional data;
predict a base plane of the object based on the aligned first and second multi-dimensional data; and
calculate a volume of the object based on the predicted base plane of the object.
